(19) United States
(12) Patent Application Publication
(10) Pub. No.: US 2014/0172750 A1
(43) Pub. Date: Jun. 19, 2014

(54) Leveraging to Minimize the Expected Inverse Assets

(71) Applicant: Rory Mulvaney, Fargo, ND (US)

(72) Inventor: Rory Mulvaney, Fargo, ND (US)

(21) Appl. No.: 14/021,195

(22) Filed: Sep. 9, 2013

Related U.S. Application Data
(63) Continuation-in-part of application No. 13/052,065, filed on Mar. 19, 2011.
(60) Provisional application No. 61/320,483, filed on Apr. 2, 2010.

(51) Int. Cl. G06Q 40/06

(52) U.S. Cl. CPC G06Q 40/06
USPC 705/36 R

(57) ABSTRACT

In a previous disclosure it was shown that a long-term leveraging formula can be derived from a root objective function that attempts to minimize the expected inverse assets of a return distribution. In this disclosure, the inverse asset objective is more generally applied, in two additional distinct cases, to optimally leverage portfolios of investments where long term conditions do not apply. Particularly, this results in a process useful for quantitative optimization of a qualitative retirement portfolio strategy.

### 1 TECHNICAL FIELD

A very important high-level strategy in finance relates to the amount of money to place at risk, or equivalently, how much leverage to apply. In addition to being a topic in the field of finance and actuary science, this is also a field related to probability theory, because financial time series are often analyzed using probability distributions. The invention claim seems to fit most appropriately into the U.S. patent classification 705/36R, on portfolio selection, planning, or analysis.

### 2 BACKGROUND

### 2.1 Optimal Leveraging To Minimize Inverse Assets

Perhaps the most basic method to predict the future distribution of the logarithm of a stock price is to model it using Brownian motion with drift, also known as a Wiener process with drift, having a time-dependent Gaussian distribution “with drift” that may be expressed as

$$p ( x ; log ( {A}_{0} ) + uT , {σ}^{2} T ) , where p ( x ; m , {s}^{2} ) = \frac{1}{\sqrt{2 π s}} {e}^{\frac{- {( x - m )}^{2}}{2 {s}^{2}}} . \qquad ( 1 )$$

Note that p(x;m,s²) is simply a Gaussian distribution in x with mean m and variance s². In this formula, u is the growth rate per unit time T in the log-value log (A) (where A₀ represents the starting value of the stock or assets), and σ² represents the variance of the growth in log-assets per time period. In this specification the term “volatility” refers to σ (the standard deviation of the growth in log-assets per time period). Of course, more advanced models or more domain-appropriate models may be used.

As derived in [1, Section 3.2], after evaluating the expected inverse assets using Expression 1 to model the distribution of log-returns, minimization of inverse assets turns out to be equivalent to maximizing

log(A₀)+(lu(l)−1/2bl²σ(l)²)T, (2)

with the remaining variables as defined in [1], and with b=1.

Upon further simplification, the optimal leverage was found as (again with b=1):

$$optimal leverage , {l}_{opt} = \frac{u}{b {σ}^{2}} . \qquad ( 3 )$$

Despite the striking similarity of Expression 3 to the Kelly Criterion

$$l = \frac{μ}{{{σ}^{′}}^{2}} , \qquad ( 4 )$$

the two formulae differ significantly in the definitions of the variables. In the Kelly Criterion, μ represents the “expected value of the simple uncompounded percent gain for a given time period” (which could also be referred to as the linear growth rate). In Expressions 1-3, u represents the expected growth in the logarithm of the assets (which is also referred to as the log growth rate). Without a solid mathematical derivation to justify the alternative variable meaning, prior knowledge of the Kelly Criterion does not make the above derivation of Expression 3 optimal leverage obvious, because prior publication of a similar formula with very different parameter meanings is not evidence that all similar formulae having different parameter meanings are obvious.

### 2.2 Computing Combined Return Rates And Volatilities

The method for computing combined return rates and volatilities was described incorrectly in [1, Paragraphs 20-21]. Being a straightforward numerical evaluation it is not part of the newly claimed material but it is described here as an element in the preamble of claim 1 which is conventional or known, toward providing a full specification of the process.

Because growth rates add in linear space rather than log-space, a simple convolution of the log-return distributions does not suffice. For example, if the log return distributions being combined are Gaussian, with lognormal distributions in linear returns, the combined distribution of returns is a convolution of lognormal distributions, for which there is no simple exact mathematical expression (without using integrals) to compute even the resulting mean or standard deviation.

The expected log growth rate E[u_{c}] of a combination of random log return variables x₁, . . . , xₙ having leverages l₁, . . . , lₙ is a multidimensional integral over the joint distribution p( ) of all random log return variables being combined, as shown here:

$$E [ {u}_{c} ] = {\int }_{- ∞}^{∞} … {\int }_{- ∞}^{∞} p ( {x}_{1} , … , {x}_{n} ) log ( {\sum }_{i = 1}^{n} [ exp ( {l}_{i} {x}_{i} ) ] ) d {x}_{1} … d {x}_{n} . \qquad ( 5 )$$

If the random log return variables xᵢ are independent, the joint distribution may be computed as the product of the marginal distributions. In the case here where the long term marginal distributions are Gaussian and possibly correlated, p is simply the multivariate Gaussian distribution with that multidimensional mean and covariance matrix (which contains the correlation information). The corresponding combined volatility is computed according to the formula:

$${σ}_{c} = \sqrt{- {E [ {u}_{c} ]}^{2} + {\int }_{- ∞}^{∞} … {\int }_{- ∞}^{∞} {p ( {x}_{1} , … , {x}_{n} ) [ log ( {\sum }_{i = 1}^{n} [ exp ( {l}_{i} {x}_{i} ) ] ) ]}^{2} d {x}_{1} … d {x}_{n}} . \qquad ( 6 )$$

Using this method to combine multiple leveraged log return rates and volatilities into a single log growth rate and volatility for the entire portfolio, an optimization algorithm may be applied to find the optimal set of leverages such that Expression 2 is optimized.

### 2.3 Leveraging In Brackets

According to Expression 3 (with b=1), investments can be leveraged for the long term using a fairly simple formula involving only the logarithmic return rate u and the squared logarithmic volatility σ². When leveraging investments specifically for the “long term”, the idea is that every bracket of investments with “optimally leveraged return rate”

$${u}_{l} = \frac{{u}^{2}}{{σ}^{2}}$$

investments will be held long enough for their log-return distributions to become Gaussian, with leveraged mean

$${u}_{l} = \frac{{u}^{2}}{{σ}^{2}}$$

and leveraged variance

$${σ}_{l}^{2} = \frac{{u}^{2}}{{σ}^{2}} .$$

Thus, the leveraged distribution is parameterized by the only the single parameter:

$${u}_{l} = {σ}_{l}^{2} = \frac{{u}^{2}}{{σ}^{2}} , \qquad ( 7 )$$

which may be thought of as alternately either the leveraged log-growth rate or the squared volatility thereof, and there need only be a long enough period of time for the distributions of log-returns corresponding to each bracket of the value of that parameter to become Gaussian (via autoconvolution of their lognormal distributions). The time periods spent at each value of the parameter need not be contiguous, so in the long term the distribution in each infinitesimally small 1-dimensional bracket will basically become Gaussian. Even short term trading might be observed to carry a specific average leveraged growth rate and volatility.

Although the overall momentary forecast distribution of returns may change its overall parameters for u and σ², the momentary leverage may (and should) always be adjusted to be the optimal long term leverage.

### 3 SUMMARY

### 3.1 Technical Problems

### 3.1.1 Problem: Forecast Timeframe Not Long Enough

Especially for stakes with less common values of

$$\frac{{u}^{2}}{{σ}^{2}}$$

or those with return distributions that stay non-Gaussian longer, sometimes investments may have a planned sale in the medium-term future (relative to the time required for its return distribution to become Gaussian); perhaps it is uncertain whether they will be held for the long term; or maybe the stake's forecast distribution is not valid all the way up to a planned future cashout. Then the long term leveraging process in [1] might not apply, and it is probably better to optimize leverage using the more general expected inverse asset objective.

3.1.2 Problem: Planned Deleveraging (Cashout) At A Specific Time In the Future

If a stake, along with its entire class of stakes having similar return distribution characteristics, is planned to be wholly or partially cashed out of, permanently, within a time period shorter than the time required for the log-return distribution to become Gaussian, the long term leveraging process in [1] might not apply. As the time to cashout gets closer, the forecast distribution at cashout becomes less and less Gaussian, changing the optimal leveraging as time passes. Complicating the matter further, more cashouts are expected due to these future leveraging changes, making the leverage in one future time segment dependent on the leverage in the next time segment.

### 3.2 Solution To Technical Problems

### 3.2.1 Solution: Forecast Timeframe Not Long Enough

If there is no set cashout date, there is basically a “rolling objective evaluation date” that might be limited by the maximum timeframe of a return distribution's forecast. Then one might choose to apply the more general objective of minimizing the expected inverse assets (originally suggested in [2, Section 9], and [3, Paragraph 13]) in some timeframe near the expiration of the current, but continuously extended and updated, forecast. For example, continuously optimize leverage for some time T months (perhaps 6 months) into the future. As such, the process is to apply an appropriate optimization algorithm to find the current optimal leverages for each stake in the current portfolio such that the expected inverse assets at time T, according to the forecast distributions, is minimized. Convolutions of leveraged return distribution forecasts for each stake must be computed to form the distribution that is the leveraged combination of several stakes.

### 3.2.2 Solution: Planned Deleveraging (Cashout) At A Specific Time In the Future

If there is only the single deleveraging constraint that the entire portfolio be liquidated by time T, the objective function is to minimize the expected inverse assets of the portfolio's forecast return distribution at time T. Because the position is expected to be liquidated by a fixed time, and there is less and less time for the return distribution to become Gaussian, the leverages of the stakes in the portfolio will continually change as the time approaches T, and this expectation of early deleveraging will create further dependency from one time segment to the next. Therefore, an acceptable algorithm would be to work backward in optimizing time segments, from the final to the start, by fixing the optimal leverage in the final time segment first, and optimize each successive time step up to the first. First, the optimal leverages for each stake in that final optimizing time segment are found using an appropriate optimization algorithm to tune the leverages of each stake in that time period, given the return distribution's forecast for that time period and the fact that leveraged return distributions are convolved together to combine them. Then step backward through the optimizing time segments, finding the optimal set of portfolio leverages (in each arbitrarily small optimizing time segment) such that the expected inverse assets of distribution p is minimized, where p is the convolution of the individual stakes' return distributions in the current time segment, convolved with the already-optimized distribution for all subsequent time segments.

If there are liquidation constraints at multiple timepoints, it may be reasonable to minimize an objective function formed as a weighted mean of the expected inverse assets evaluated at various timepoints, denoted by Tᵢ, where the Tᵢ are also exactly the times where leverage constraints are imposed. More generally, if X(T) is a random variable denoting X assets at time T units into the future, the objective function to be minimized might take the form

f(E[1/X(T₁)], E[1/X(T₂)], . . . E[1/X(T)]), T₁<T₂< . . . <Tₙ. (8)

That is, minimization of any function f of the expected inverse assets evaluated at distinct future timepoints.

If the assets are not supposed to be fully liquidated by Tₙ, there are no Tᵢ between the final leveraging constraint and Tₙ, making the final optimizing time segment of interest (an optimizing time segment is an arbitrarily small time segment with constant leverage, not to be confused with a time period from Tᵢ to Tᵢ₊₁) a single time period with constant portfolio leverages from Tₙ₋₁, or 0 (if n=1), to Tₙ. The final Tₙ, which could also be infinite, would then be considered to be a “rolling objective evaluation point”, with the expectation that the final Tₙ remains to be a fixed value (offset relative to the current time) as time passes.

Optimization of the leverages in each arbitrarily small time segment would be much more complicated if n>1 in Expression (8), due to the inability of the above-described backward-stepping method to take into account the inverse assets from all of the as-yet unoptimized time points Tᵢ in Expression (8). Therefore optimization would probably involve simultaneous optimization of all portfolio leverages in at least all the optimizing time segments between T₁ and Tₙ.

### 3.3 Advantageous Effects of the Invention

The method presented in Section 3.2.2 solves the problem of how to quantitatively structure a retirement fund portfolio to optimize the level of risk, using a strong mathematical basis. This objective strategy could result in greater financial stability in the lives of millions of people, further resulting in a stronger, more broad-based, national economy. Equities markets could become more immune to crashes, due to greater common understanding of their risk levels.

### DESCRIPTION OF EMBODIMENTS

### 4.1 Example: Leveraging In Market Equities

For basic application of optimal leverage from Expression 3 (with b=1) (which was analytically derived from the claimed Expression 2), a market equity can be modeled by Brownian motion with drift, parameterized by u and σ. The determination of u and σ from raw data is a separate non-trivial process in itself (for example, see literature on GARCH for volatility estimation), but if it is known or hypothesized that the data are produced from a particular random model with known parameters, then u (also known as the exponential growth rate) is defined as the expected increase (given that particular random model) in the log-price per time period, and σ (also known as the volatility) is defined as the standard deviation (given that particular random model) from u of those log-price changes per time period.

Analysis, though straightforward by utilizing the same known principles, can become quite complex if the cost of interest for borrowing under high leverage is taken into account, along with the “risk-free” interest rate, and the volatilities of these rates. Another somewhat complicated matter is how to balance a portfolio containing multiple equities. If multiple investments modeled using Brownian motion with drift in the logarithmic domain are to be combined together, they should be analyzed with the help of convolution methods described in [1, Section 3.2.1] and 2.2.

### 4.2 Example: Leveraging In Blackjack

Suppose that p (distinct from the Gaussian probability density function defined earlier in Expression 1) is the Bernoulli probability of winning a hand of blackjack. Suppose also that f is the chosen fraction of the current assets to bet on each hand, effectively representing the leverage. Then the expected increase in log-assets after one hand is given by Expression 9.

u=plog(1+f)+(1−p)log(1−f) (9)

The variance of the increase is given by Expression 10.

σ²p(log(1+f)−u)²+(1−p)(log(1−f)−u)² (10)

The number of wins after any number of hands played has a binomial distribution, and for a large number of hands that distribution becomes Gaussian. Given that n hands are played, Expression 11 shows that the only random variable involved in the increase in log-assets is the number of wins w (because f and n are constants), and the expression is linearly dependent on w. Thus the distribution of the increase in log-assets after a large number of hands is also Gaussian distributed, along with w.

Increase in log-assets=wlog(1+f)−(n−w)log(1−f) (11)

Because the future distribution of log-assets is Gaussian, the optimal leverage criterion for Gaussian distributed changes in log-assets from Expression 3 (which was analytically derived from the claimed Expression 2), with b=1 in that expression, can be directly applied using Expressions 9 and 10. Simple numerical optimization (or a table lookup) is needed to find the value of the leverage f (represented by l in 3) that satisfies the optimal leverage criterion. A simple trial and error search algorithm would suffice to solve it, because it involves optimization of only 1 parameter, f, because the probability p of winning each hand, is fixed.

### 4.3 Example: Leveraging With Debt

The root objective of minimizing the reciprocal assets seems to imply that the assets must be positive, in order for the objective to be applicable. However, because the reason for minimizing the reciprocal assets is to avoid bankruptcy, the objective given in Expression 2 also functions in cases where the net assets are negative, simply by considering the assets in the criterion in Expression 2 to be equal to A₀, the amount used in the denominator component of the leverage (as defined in [1, Section 2])—the amount of assets considered eligible for investment, which could include available debt.

If the debt taken has a repayment schedule, as opposed to debt without a repayment schedule such as that in a margin account, the repayment requirements usually increase with time, degrading the growth rate in the future. Thus to maintain low risk of bankruptcy in the future, a forecast is required of the earnings and volatility, and preferably their dependence on leverage, through time. Given this general forecast, the goal should be to apply a debt payoff and investment strategy (controlling the leverage through time) that aims for a steady exponential growth rate in the assets (which are considered eligible for investment) while basically maximizing the minimum, over time T, of the expected value of the function

F(t)=log(A₀)+∫^{T}₀(l(t)u(t,l)−1/2l(t)²σ(t,l)²)dt, (12)

where F(t) is the objective function from Expression 2 modified with b=1, as well as giving time dependence based on the forecast of u and σ, and integrating over the time-dependent portion of the function. The claimed Expression 2 is the basis for the integrand, which is integrated here with additional time dependence, and then maximized.

The optimal amount of debt to carry has also been determined, because both the debt payoff schedule and the possibility of taking additional debt were considered in the optimization process.

### 4.4 Example: Leveraging In Insurance

Over the long term, the insurance premium per unit of insurance averages out to be greater than the average cost resulting from insurance claims, per unit of insurance, allowing the insurer to provide even more units of insurance that earn greater profits in total, probably resulting in exponential growth while the market expands. Sale of insurance is a type of financial investment, because having the ability to pay out claims means that money must be held in reserve as an investment. However, because the cost of claims over a time period is actually a random variable c, the amount of the investment should probably be considered as being the expected value of the claims over that time period, or E [c].

Denoting the random variable for claims as c and using r as the (relatively) certain amount of revenue, the expected log-growth rate u (with leverage=1) is calculated as u=log(1+(r−E[c])/E[c])=log(r)−log(E[c]). The variance in the growth of log-assets for an interval of time T is basically computed as Tσ²=Var(Σᵢ₌₁^{T} ûᵢ)=TE[(log(r)−log(c)−u)²], where ûᵢ is considered to be the observed log growth rate over the i^{th} time interval. Here the second equality is due to the fact that the variance of a sum of independent random variables is the sum of variances of the variables.

Knowing u and σ, the analyses from Sections 4.3 and [1, Section 3.2] (specifically the claimed Expression 2 and Expression 12) are now applicable for the determination of the optimum safe leverage in terms of the optimal expected cost in claims that can be safely paid out (the leverage is the expected cost in claims divided by the assets available for investment). Leverage should be continually corrected to keep it approximately on-target , due to changes in available assets to invest (from the beginning of [1, Section 3.1]), or due to trend dynamics (from [1, Section 3.2.2]). This tuning of the leverage is done by buying and selling excess units of insurance or some other well-quantified financial instrument to offset the risk of a good or bad year for insurance claims. These transactions could take place in some type of market with other insurers and possibly reinsurers.

The problem mentioned about trend dynamics in [1, Section 3.2.2] should be less troublesome to predict in insurance, compared to equity markets, because insurance claims are probably less dependent upon complex quickly-changing social factors.

### 4.5 Example: Leveraging In A Retirement Portfolio

The framework from Sections 3.1 and 3.2 is used to basically determine the quantitative investment strategy, with only the amounts to cash out left to be determined. One possible method is to cash out a certain amount every month, after a certain date, until the money runs out. For purposes of computing leverage, the money cashed out is considered part of the total assets available to invest, but it is actually being spent every month. First, estimate the median number of months M that income will be required for, and liquidate 1/M of the leverage every month after the starting cashout date. Given that cashout schedule, the reasoning and processes described in Sections 3.1 and 3.2 may be applied.

### 5 INDUSTRIAL APPLICABILITY

Inverse asset optimized leveraging is a process that could be applied individually to millions of retirement accounts, to quantitatively optimize a qualitative strategy. General wasteful uncertainty about market risk levels could be greatly reduced by increased consensus brought about by the mathematical soundness of the expected inverse assets objective.

### REFERENCES

[1] R. Mulvaney, “Leveraging to minimize the expected multiplicative inverse assets,” U.S. Utility patent application Ser. No. 13/052,065, Mar. 2, 2011.

[2] R. Mulvaney and D. S. Phatak, “Regularization and diversification against overfitting and over-specialization,” University of Maryland, Baltimore County, Computer Science and Electrical Engineering TR-CS-09-03, Apr. 3 2009.

[3] R. Mulvaney, “Leveraging to minimize the expected multiplicative inverse assets,” U.S. Provisional 61/320,483, Apr. 2, 2010.

1. For investments, defined as money placed at risk in return for potential gain, held long enough in total for the uncertain return distribution to be characterized approximately as a Gaussian distribution with drift in the logarithm of the investment value (as in Expression 1), the derivation and invention of a financial portfolio planning and analysis process (classification 705/36R) is claimed, using:
standard forecasts for all portfolio components of the log-growth rate u and the variance σ² of the of the above Gaussian distribution;
standard computation of leveraged, combined log return rates and volatilities to combine forecasts of multiple investments into a single portfolio-wide growth rate and volatility (as specified in Section 2.2) based on the leverage vector; and
a standard optimization algorithm to determine the optimal portfolio leverage vector (where leverage is defined in the first paragraph of [1, Section 2]) to invest;
wherein the improvement is:
to maximize, via optimal modification of the leverage l, the value of the newly presented and logically sound objective function (upon which optimality is based) in Expression 2 for values of the constant b ranging from 4/5 to 5/4, inclusive (most preferably 1).

2. For investments having a set cashout date or partial cashout dates, and are not necessarily held long enough for the log-return distribution to be characterized as Gaussian with drift, the derivation and invention of a financial portfolio planning and analysis process (classification 705/36R) is claimed, using:
standard forecasts of the return distributions of the components of the portfolio; and
standard optimization methods to compute the optimal leverage of each portfolio element for the current time step, as described in Section 3.2.2;
wherein the improvement is:
to minimize a function of the form given in Expression 8.

3. For investments not necessarily held long enough for the log-return distribution to be characterized as Gaussian with drift, the derivation and invention of a financial portfolio planning and analysis process (classification 705/36R) is claimed, using:
standard forecasts of the return distributions of the components of the portfolio;
standard computation of the expected inverse assets at some time T in the future; and
a standard optimization algorithm to determine the optimal vector of portfolio leverages to invest;
wherein the improvement is to:
minimize the expected inverse assets of the return distribution at the “rolling objective evaluation date”, as described in Section 3.2.1.
